(19) United States
(12) Patent Application Publication
(10) Pub. No.: US 2022/0034162 A1
(43) Pub. Date: Feb. 3, 2022

(54) ROLLER SHUTTER LOCK ASSEMBLY

(71) Applicant: CW PRODUCTS PTY LTD., Murray Bride, South Australia (AU)

(72) Inventor: Ibrahim ELASSAAD, Murray Bride, South Australia (AU)

(21) Appl. No.: 17/279,669

(22) PCT Filed: Sep. 28, 2019
(86) PCT No.: PCT/AU2019/051036

§ 371 Date: Mar. 25, 2021

(30) Foreign Application Priority Data
Sep. 28, 2018 (AU) 2018903677

(51) Int. Cl. E06B 9/86; E05B 15/10; E05B 65/00

(52) U.S. Cl. CPC E06B 9/86; E06B 2009/802; E05B 65/0021; E05B 15/101

(57) ABSTRACT

A shutter locking assembly that has a bolt carriage with a bolt slidingly engageable with the bolt carriage and a biasing (actuator) means operatively connected to the bolt member and the bolt carriage. The bolt carriage is inserted into a cavity of a shutter slat, and the action of moving the shutter slat between an up (open) position and a down (locked) position, causing the bolt to be moved between an extended position and a retracted position. When the shutter slat is in a down (locked) position the bolt engages with a bolt receiving opening adjacent to the shutter slat, and when in an up (open position) the bolt is retracted

### FIELD OF THE INVENTION

The present invention relates to a locking arrangement for securing a plurality of pivotally connected slats forming a roller shutter.

In particular, the present invention relates to a locking means for a roller shutter into a preset position or location by way of locking engagement to a side rail/guide rail.

### BACKGROUND

Roller shutters use a curtain of interconnected slats that typically travel in a pair of opposing side guide rail or guide tracks. The formed curtain is arranged so as to move between an open rolled up position and a lowered closed rolled down position which may be undertaken either by manual movement of the shutters or alternatively by using a motor to drive a shaft onto which the curtain of interconnected slats is wound around. Roller shutters are commonly used as they provide strength and security in both industrial and commercial buildings as well as in residential buildings.

Roller shutters can be easily actuated to move between the open and closed positions, were in the open position provides an unhindered view of the outside of the building/dwelling and when the roller shutter is lowered into the fully closed position provides security to the inside of the dwelling/building. In certain arrangements the shutter may be held in the closed position by the force of the motor connected to the shaft upon which the shutters are wound.

In such situations then it is only the resiliency of the motor resisting the urge to rotate that may be preventing a closed shutter arrangement from being forced into an open position. If sufficient force is provided to overcome the blocking force of the motor then the motor will give way and the window shutter can be opened. This may occur for example when a leveraging bar is placed underneath a bottom rail of a closed shutter and excessive force applied downwardly on the leveraging bar.

To counter this, some roller shutter arrangements include a key locking bar integrated into the bottom most slat. The locking bar is typically key actuated to move the bar from a locking position to an unlocking position wherein the locking bar engages with openings in the side guide rails so that if a leveraging bar is placed underneath the bottom rail then the force applied to the leveraging bar has to also overcome the resistance provided by the engagement of the locking bar with the side guide rails.

One of the problems with the use of a keyed locking bar in the bottom rail or/is that it needs to be manually actuated by rotation of either a suitable handle mechanism or rotation of a key in a lock assembly. Having a handle mechanism on window slats is generally seen as aesthetically unpleasing and also provides hinderance to the operation of the slats/shutter curtain as it prohibits the complete opening of the curtain into a fully retracted or open position due to the projecting handle abutting against the uppermost portion of the window frame.

Additionally, when using a keyed locking bar, the operator has to be careful to ensure that the locking by is fully retracted prior to opening the window shutter to avoid the locking bar jamming against an inner surface of the guide rails. Another problem with keyed locking bars is that in order to be operated a key has to be inserted and rotated in the lock requiring a user to ensure that they have ready access to the required keys in order to lock the roller shutter as well as open it. Typically locking bars of the type described also increase the noise created by the shutter assembly as it opens and closes due to the locking bar rattling within the bottom rail.

### OBJECT OF THE INVENTION

It is an object of the invention to overcome or at least substantially overcome the disadvantages and shortcomings of the prior art.

Other objects and advantages of the present invention will become apparent from the following description, taking in connection with the accompanying drawings, wherein by way of illustration an example, an embodiment of the present invention is disclosed.

### SUMMARY OF THE INVENTION

According to the present invention, although this should not be seen as limiting the invention in any way, there is provided a shutter locking assembly including:
a bolt carriage;
a locking bolt slidingly engageable with the bolt carriage;
a biasing (actuator) means operatively connected to the locking bolt and the bolt carriage;
the bolt carriage being inserted into a cavity of a shutter slat, the locking bolt being movable within the cavity relative to the shutter slat between an up (open) position and a down (locked) position, the locking bolt being movable between an extended position and a retracted position by action of the biasing (actuator) means within the shutter slat cavity, the shutter slat when in a down (locked) position urges against the biasing (actuator) means to extend the locking bolt to engage with a locking bolt receiving opening adjacent to the shutter slat, and when in an up (open position) the locking bolt is retracted.

In preference, the biasing means is a spring means.

In preference, the spring means is a single leaf spring.

In preference, the spring means is a torsion spring.

In preference, the actuator may be a mechanical linkage between the shutter slat and the bolt.

In preference, the bolt includes an opening for receiving a pin, wherein the biasing means connects to the pin.

In preference, the biasing means has a first connection end and a second connection end, the first connection and being removably connected to an end of the bolt. The second connecting end being removably connectable to a connecting portion of the bolt carriage.

In preference, the bolt carriage includes a slide/groove for receiving the bolt.

In preference, the bolt carriage includes a bottom rail portion.

In preference, the bottom rail portion slidingly connects to the bolt carriage.

In preference, the bolt carriage includes a stop in the slide/groove to restrict the travel of the bolt within the bolt carriage.

In a further form of the invention there is a roller shutter assembly which includes a plurality of shutter slats pivotally or hingedly interconnected with one another, at least one shutter slat having a cavity, a locking assembly including:
a shutter slat having a cavity;
a bolt carriage;
a locking bolt slidingly engageable with the bolt carriage;
a biasing (actuator) means operatively connected to the bolt and the bolt carriage;
the bolt carriage being inserted into a cavity of a shutter slat, the locking bolt being movable within the cavity relative to the shutter slat between an up (open) position and a down (locked) position, the locking bolt being movable between an extended position and a retracted position by action of the biasing (actuator) means, the shutter slat when in a down (locked) position urges against the biasing (actuator) means to extend the locking bolt to engage with a locking bolt receiving opening adjacent to the shutter slat, and when in an up (open position) the locking bolt is retracted.

In a further form of the invention there is a shutter locking assembly including a bolt carriage; a locking bolt slidingly engageable with the bolt carriage between an extended position and a retracted position; a biasing (actuator) means operatively connected to the locking bolt and the bolt carriage; the bolt carriage being inserted into a shutter slat cavity, the locking bolt being movable by movement of the shutter slat between an up (open) position and a down (locked) position, by action of the biasing (actuator) means within the shutter slat cavity, the shutter slat when in a down (locked) position urges against the biasing (actuator) means to extend the locking bolt to engage with a locking bolt receiving opening adjacent to the shutter slat, and when in an up (open position) the locking bolt is retracted

In preference, the shutter assembly includes at least one elongated guide track.

In preference, the assembly includes a pair of elongated guide tracks, the roller shutter being supported in the guide tracks for bidirectional sliding movement between an open position and in a closed position.

In preference, when in a closed position, a shutter slat urges against the spring biasing means which moves the bolt (locking bolt) from a retracted position to an extended position the locking bolt extends from the bolt carriage and into a substantially aligned opening within an adjacent elongated track or guide rail having an opening thereon.

In preference, the assembly includes one or more of the locking assemblies located along a periphery of the shutter slats.

### BRIEF DESCRIPTION OF THE DRAWINGS

By way of example, an embodiment of the invention is described more fully in hereafter with reference to the company drawings, in which:

FIG. 1 is an exploded perspective view of an embodiment of the present invention;

FIG. 2A is a cut away view of an embodiment of the present invention showing the locking bolt in a retracted position, the shutter slat being in an up (open) position;

FIG. 2B is a side view of the assembly shown in FIG. 2A in an up (open) position;

FIG. 2C is a perspective view of the assembly from FIG. 2B;

FIG. 3A is a cut away view the same as shown in FIG. 2A with the assembly being in and down (closed) position with the locking bolt being retracted within the bolt carriage;

FIG. 3B is a side view of the assembly shown in FIG. 3A in a down (closed) position;

FIG. 3C is a perspective view of the assembly shown in FIG. 3B;

FIG. 4 is a perspective view and of the present invention, showing a portion of the roller shutter assembly in cross section, in an open position;

FIG. 5 is the same view as FIG. 4 however with the shutter assembly in the closed position showing the engagement of the locking bar with the receiving slot in the side guide rail;

FIG. 6 is a close up of section A from FIG. 5.

FIG. 7 is a cross sectional side view of the present invention with a different biasing means connected to the locking bold and bolt carriage.

### DESCRIPTION OF THE INVENTION

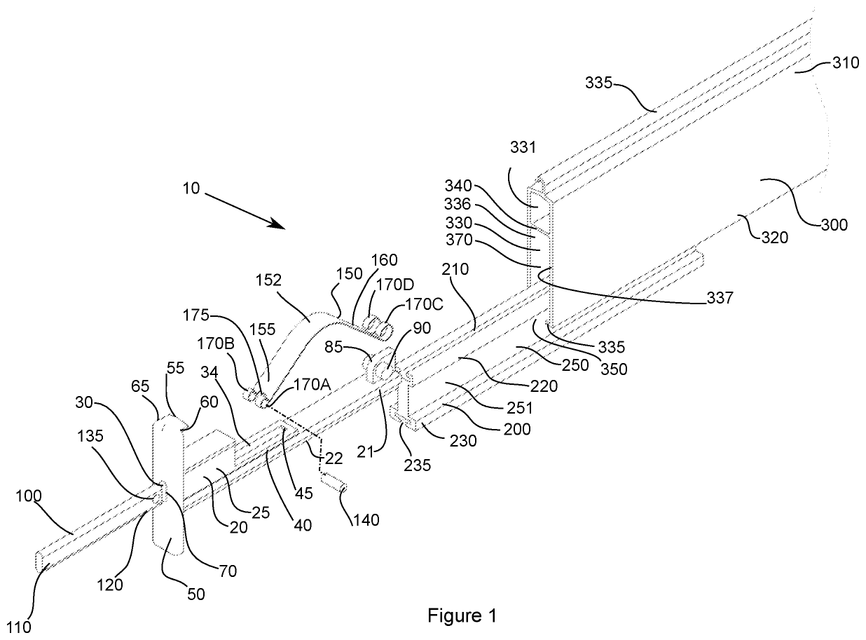

With reference to FIG. 1, the shutter blocking assembly 10 includes a lock carriage 20 having a sleeve section 25 that includes a bore 30 extending through. A channel or groove 34 extends along the rear portion 40 which includes a back stop 45. An endcap 50 is opposite to the rear portion 40 and may be integrated with the carriage 20 or separately affixed. The endcap 50 includes a tab portion 55 with indented sides 60 and 65 respectively and an opening 70 on face 66. A locking bolt or bar 100 has a front end 110 and a rear end 120, the rear end 120 including an opening 135 which is transverse to the longitudinal length of the locking bolt. The outer peripheral shape of the locking bolt 100 is shaped to fit within the opening 70 of the endcap 50 and thus into the bore 30 of the sleeve section 25. The rear end 120 of the locking bolt 100 then can slide along the groove 34 of the rear portion 40 and when fully inserted the rear face of the rear end 120 abuts the stop 45 and the front end 110 of the locking bolt 100 is then either flush with the outer surface of the endcap 50 or recessed within the sleeve section 25 so that it no longer projects out from the endcap 50.

A biasing means (actuator), in this embodiment the leaf spring (parabolic spring) 150 having a first end 155 and a second end 160. At both the first end and a second end 155 and 160 there are a pair of eyelets 170A, 170B and 170C, 170D with a notch 175 located between each pair. The spring 150 is removably connected to the locking bolt 100 by alignment of the hole 135 on the rear end 120 of the locking bolt 100 with the eyelets 170a, 170B at the first end 155. The pin 140 is then inserted through the first eyelet 170A and then into the hole 135 and into the adjacent eyelet 170B. In this manner the spring 150 becomes connected to the locking bolt 100 but allows the spring to pivot.

In other forms of the invention, a torsion spring may be used in place of the parabolic spring, the torsion spring have a first leg and a second leg, the first leg being connected to the rear end 120 of the locking bolt 100 and the second leg of the torsion spring being connected to the rear end 95 of the lock carriage 20.

In yet other forms the locking bolt can be actuated by way of a direct mechanical linkage, or push rod arrangement that urges against the locking bolt when the shutter is moved to the closed position.

At the second end 160 of the spring 150, the eyelets 170C, 170D are aligned with the hole/opening 80 on the tab 85 located on the end 21 of the carriage 20. A pin 90 is then inserted through the first eyelet 170C on the second end 160, through the hole 80 of the tab 85 and then into the second eyelet 170D. The spring 150 is now connected at one end to the carriage 20 and at the other end attached to the locking bolt 100. Pressing down on the top surface 152 of the spring 150 then causes it to straighten out and as it is connected at one end to the fixed tab 85 then it forces the locking bolt outward away from the fixed tab 85, extending the locking bolt into its extended position out through the endcap 50. Releasing pressure on the spring 150 results in retraction of the locking bolt 100 back into this sleeve section 25.

In the present embodiment the carriage 20 slidingly engages with a longitudinal bottom rail portion 200 having an I-beam shape with a slot 210 in the upper flange 220 shaped to receive the longitudinal projecting ridge 22 on the lower face of the carriage 20. In other embodiments the carriage 20 and bottom rail portion 200 may be molded or integrated into a single component without departing from the scope of the invention. The bottom rail portion 200 has an upper flange 220 with slot 210 and a lower flange 230 with slot 235, which makes the bottom rail portion 200. The lower flange 230 and rail acts a closed position end stop against the location 335 in FIG. 1. Also inserted in the bottom rail 200 is a rubber cushion seal to seal the curtain against abutting surface which it may land on when in the closed position. Between the upper and lower flange 220, 230 is the web 250 having sides 251 and 252 respectively. The distance between the upper flange 220 and the lower flange 230 is sufficient to allow the parabolic spring to be pressed enough to push bolt 100 to the locked position.

As shown in FIG. 1, there is a window slat or shutter slat 300, which in this embodiment is substantially hollow having an upper end 310 and a lower end 320. Typically such slats are made from extruded aluminium or plastic material and further have a joining hinge or connection structure 335 on the upper end 310 with which to hingedly connect to a lower connecting channel in an upper adjacent slat to provide an interconnected articulated curtain. Some slats are curved or have non-parallel sides, in the present embodiment the slat 300 is generally hollow and contains at least a main channel 330 which is defined by the side's 336 and 337 which are in generally parallel orientation with one another and a roof section 340 substantially perpendicular to the sides 336 and 337.

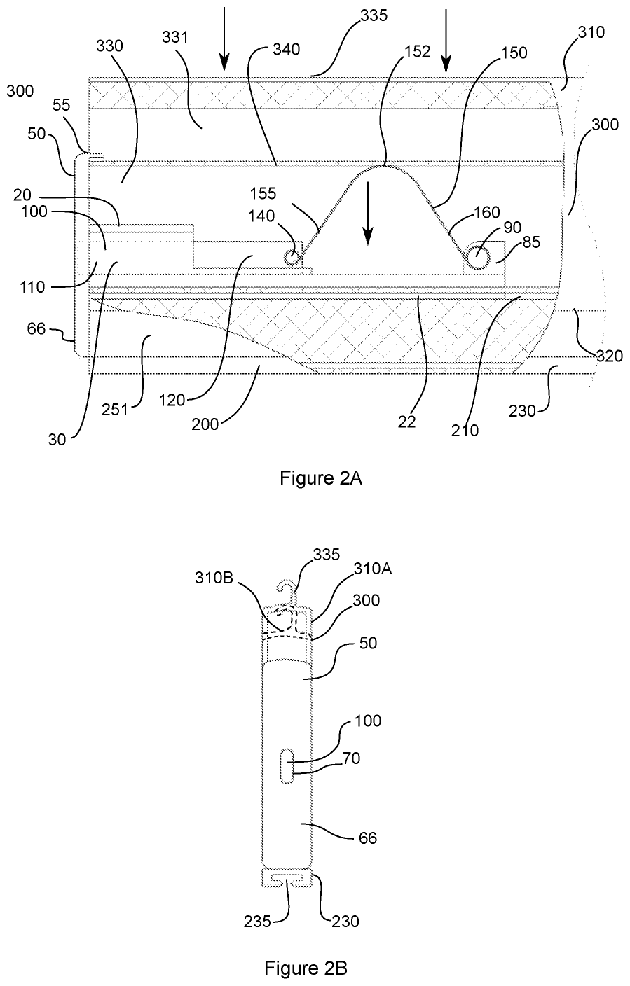

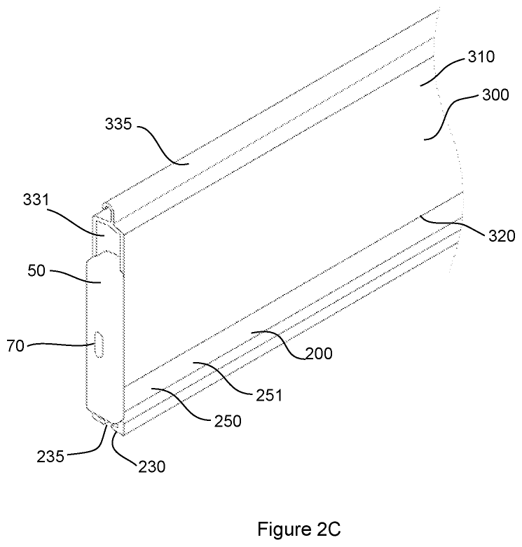

FIG. 2A shows a side view of the window slat or shutter slat 300, with a partial cut-away of the shutter slat 300 to see the interior arrangement.

FIG. 2B is the end view of the window slat or shutter slat 300, with the endcap 50 includes a tab portion 55 with indented sides 60 and 65 respectively and an opening 70 on face 66, with the upper end 310A being the position of the shutter slat 300 in the open position, and the broken line 310B being the position of the shutter slat 300 in the closed position. FIG. 2C shows the side perspective view of the shutter slat 300.

As shown in FIG. 1, a longitudinal slot opening 350 spans substantially the length of the slat 300 and has a pair of inwardly projecting flanges 355, 356 (not shown). The bottom rail portion 200 can slide readily into the opening 370 of the main channel 330, along with the carriage 20, the endcap 50 body 20 have a clearance fit to opening 370. Body 20 is fixed to the bottom rail via grove 210 and moves in unison with the bottom rail. Tab 55 of the end 50 nestingly engaging, in this embodiment, with the secondary channel 331 to provide a clearance fit engagement. The inwardly projecting flange is captively holding the bottom rail portion 200 within the main channel 330 as the upper flange 220 of the bottom rail portion 200 are not able to pass over the inwardly projecting flanges 355, 356. The slats 300 however can move from an upper position where the inwardly projecting flanges 355, 356 are in close proximity to or touching the upper flange 220 of the bottom rail portion 200 and the down (locked) position where the inwardly projecting flanges 355, 356 rest in close proximity to or on the lower flange 230 of the bottom rail portion 200. By this up and down movement of the slat 300, the roof section 340 in the main channel 330 presses or urges against the top section 152 of the spring 150 resulting in a straightening of the spring 150 that causes the locking bolt 100 to be extended outwards.

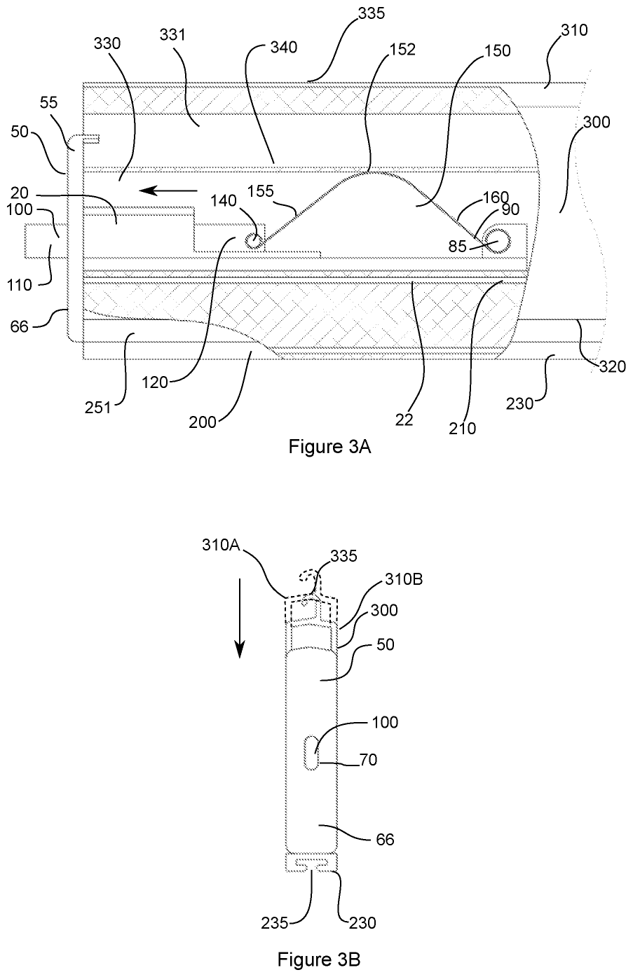

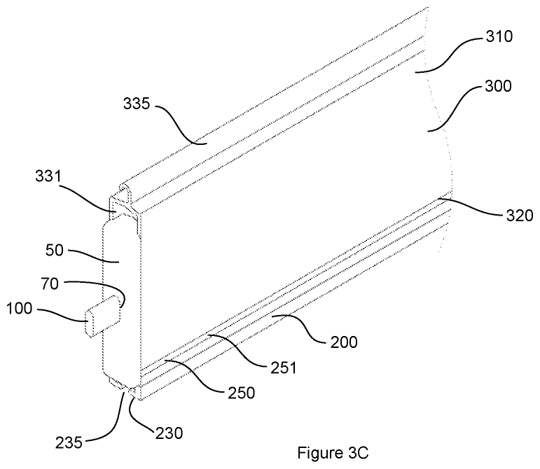

As shown in FIG. 2A, the section 340 rests against the top section 152 of the spring 150 and the bolt 110 is in the fully retracted position within the carriage 20. Pushing the slat 300 downwards, as shown in FIG. 3A, thus causes the section 340 to push against the top section 152 of the spring 150 thus forcing the locking bolt 100 outwards.

FIG. 3B is the end view of the shutter slat 300 from FIG. 3A and the upper end 310B in the closed position (lowered) from the raised (open) position 310A.

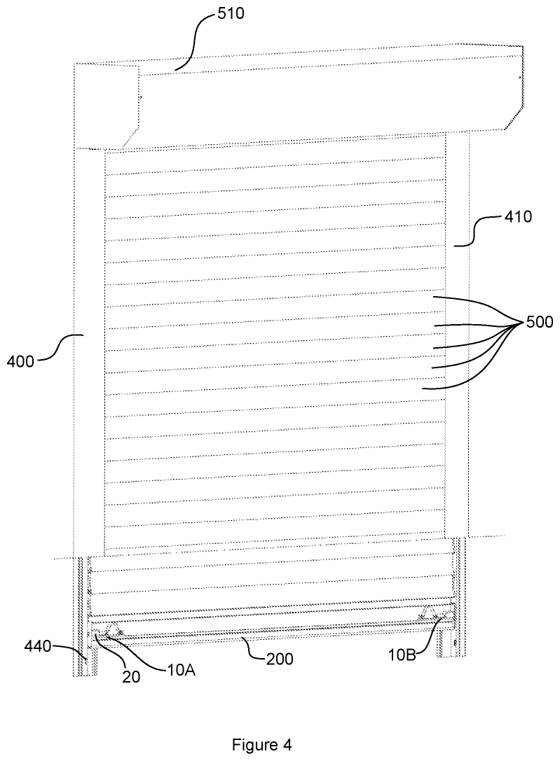

Referring to FIG. 4, a plurality of slats 500 are positioned in an open position and are connected one on top of the other to form a shutter/curtain that when in a fully opened position is concealed generally within a shutter box 510. As the slats travel generally in a pair of longitudinal guide tracks or guide rails 400, 410, which can be integrated with an adjacent window frame or suitable structure. On each outer end of the lowermost slat there is a locking assembly 10 as described, referred to as 10A and 10B. Any number of locking assemblies 10 may be used in the slats of the shutter assembly, for example, there may be additional locking assemblies located in the slats that are not the lowermost slat.

A suitably shaped hole or opening 440 is formed in the guide rail 400 and 410 at the required location such that when the locking bolt 100 is in its extended position, when the slat 300 is pressed or forced downwards, the bolt 100 then slidingly engages with the opening 440 in the guide rail locking the interconnected shutter slats in place within the guide rails 400 and 410.

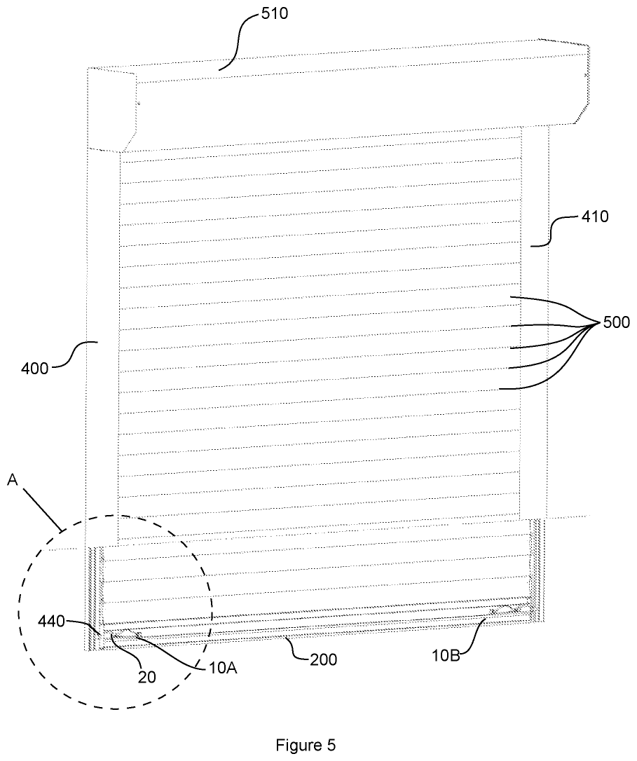

FIG. 5 shows the plurality of slats 500 in a lowered position and the locking bolt extended into the suitably shaped adjacent locking bolt receiving hole or opening 440.

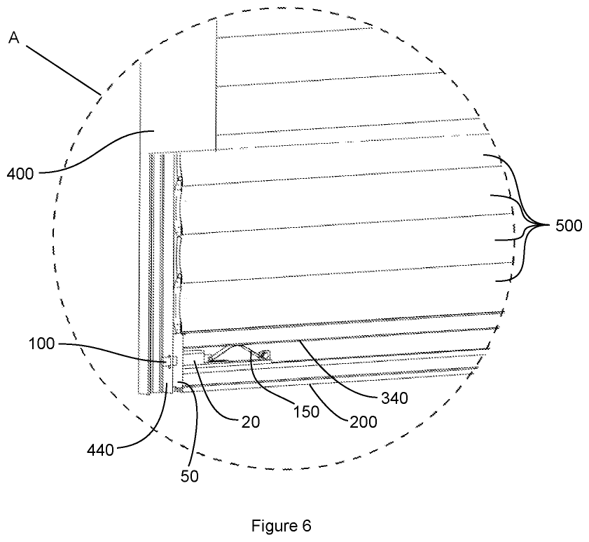

FIG. 6 shows the locking bolt 100 extended into the suitably shaped adjacent locking bolt receiving hole or opening 440, which can be any suitably shaped opening to receive a shape of locking bolt as required. The section 340 urges against the spring 150 to force the locking bolt 100 into the extended position.

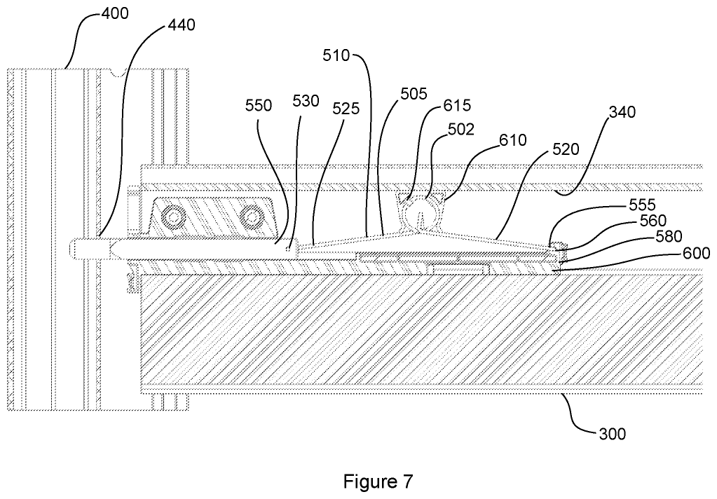

Referring to FIG. 7, this shows a cross section view of the present invention with the biasing means being torsion spring 505 having a coil 502 and a first leg 510 and a second leg 520, each leg terminating in right angle ends 525 and 555 respectively to allow insertion of the right angle end 525 into the opening 530 of the locking bolt 550. The right angle end 555 of the second leg 520 is inserted into the opening 560 in the end 580 of the carriage 600.

The coil 502 of the torsion spring 505 nests within the block 610 upon which the section 340 of the slat 300 can engage or abut to urge against when the slat 300 is moved to the lowered (closed) position thus forcing the leg 510 outward and forcing the locking bolt 550 outwards and into a suitably aligned opening in an adjacent locking bolt receiving opening 440 in the side guard rail 400. The block 610 includes locking tabs 615 that hold the coil 502 in place.

In this way the action of closing the window slats either by an electrically operated motor driven system or manually results in the locking bolt 100 moving from an open retracted position within the carriage 20 to an extended locked position without the operator having to remember to operate any locking functionality. If the shutter slat assembly is motor driven a motor drive is also included then this also helps to retain the slats in the locked or closed position due to the resistance of the motor to turn without power.

In some embodiments an indicator panel may be visible on the outer surface of the slat within which the locking assembly of the present invention resides so as to provide the user with a visual indicator that the locking assembly/mechanism is in the locked position. This may be, for example, by way of exposing a coloured indicator section on the sliding bolt 100 when fully extended reveals the coloured section through a small window on an inner side of the shutter. This would then allow the user to quickly determine if the locking assembly had fully extended or if there was a potential obstruction preventing the locking bar from fully engaging as required.

Accordingly, when in use, and in a closed position, the present invention provides for an economical and effective locking assembly/method, to prevent and or hinder any unwanted opening. If, for example, an intruder was to insert a leveraged bar between the bottom rail 200 and adjacent window sill and apply leveraging force, the amount of force required to force the window slats open is greatly increased as the locking bolt 100 of the assembly 10 has engaged with the locking bolt opening 440 in the side guard rail 400. By using a suitably hardened locking bolt 100 and hardened material in the guard rail the amount of force required to break the lock becomes significant. Moreover the force applied by the leverage bar also urges the shutters closer together which in turn keep the force on the spring 150 preventing the accidental retraction of the bolt 100 into the carriage 20.

1. A shutter locking assembly including:
a bolt carriage;
a locking bolt slidingly engageable with the bolt carriage between an extended position and a retracted position;
a biasing (actuator) means, being a leaf spring or torsional spring, operatively connected to the locking bolt and the bolt carriage;
the bolt carriage being inserted into a shutter slat cavity,
the locking bolt being movable by movement of the shutter slat between an up (open) position and a down (locked) position, by action of the biasing (actuator) means within the shutter slat cavity, the shutter slat when in a down (locked) position urges against the biasing (actuator) means, the biasing (actuator) means forcing the locking bolt out to extend the locking bolt to engage with a locking bolt receiving opening adjacent to the shutter slat, and when in an up (open) position the locking bolt is retracted.

2. (canceled)

3. (canceled)

4. (canceled)

5. The shutter locking assembly of claim 1, wherein the bolt includes an opening for receiving a pin, wherein the biasing means connects to the pin.

6. The shutter locking assembly of claim 1, wherein the biasing means has a first connection end and a second connection end, the first connection being removably connected to an end of the bolt and the second connecting end being removably connectable to a connecting portion of the bolt carriage.

7. The shutter locking assembly of claim 1, wherein the bolt carriage includes a slide/groove for receiving the bolt.

8. The shutter locking assembly of claim 1, wherein the bolt carriage includes a bottom rail portion.

9. The shutter locking assembly of claim 8, wherein the bottom rail portion slidingly connects to the bolt carriage.

10. The shutter locking assembly of claim 1, wherein the bolt carriage includes a stop in the slide/groove to restrict the travel of the bolt within the bolt carriage.

11. A roller shutter assembly which includes a plurality of shutter slats pivotally or hingedly interconnected with one another, at least one shutter slat having a cavity, a locking assembly including:
a shutter slat having a cavity;
a bolt carriage;
a locking bolt slidingly engageable with the bolt carriage between an extended position and a retracted position;
a biasing (actuator) means, being a leaf spring or torsional spring, operatively connected to the locking bolt and the bolt carriage;
the bolt carriage being inserted into a shutter slat cavity,
the locking bolt being movable by movement of the shutter slat between an up (open) position and a down (locked) position, by action of the biasing (actuator) means within the shutter slat cavity, the shutter slat when in a down (locked) position urges against the biasing (actuator) means, being a spring means, the biasing (actuator) means forcing the locking bolt out to extend the locking bolt to engage with a locking bolt receiving opening adjacent to the shutter slat, and when in an up (open) position the locking bolt is retracted.

11. (canceled)

12. The shutter locking assembly of claim 10, wherein the assembly includes a pair of elongated guide tracks, the roller shutter being supported in the guide tracks for bidirectional sliding movement between an open position and in a closed position.

13. The shutter locking assembly of claim 10, wherein when in a closed position, a shutter slat urges against the spring biasing means which moves the bolt (locking bolt) from a retracted position to an extended position the locking bolt extends from the bolt carriage and into a substantially aligned opening within an adjacent elongated track or guide rail having as opening thereon.

14. The shutter locking assembly of claim 10, wherein the assembly includes one or more of the locking assemblies located along a periphery of the shutter slats.

15. The shutter locking assembly of claim 10, wherein the shutter assembly includes at least one elongated guide track.
